(19) United States
(12) Patent Application Publication
(10) Pub. No.: US 2026/0266593 A1
(43) Pub. Date: Sep. 10, 2026

(54) APPARATUS AND METHOD FOR DETERMINING A LACQUER COATING THICKNESS ON ELECTRICAL SHEETS

(71) Applicant: EMG Automation GmbH, Wenden (DE)

(72) Inventors: Jens BUBLITZ, Pönitz (DE); Timo GEMMER, Plettenberg (DE); Mark KRESO, Rheinberg (DE)

(21) Appl. No.: 19/491,324

(22) PCT Filed: Jun. 7, 2024
(86) PCT No.: PCT/EP2024/065830

§ 371 Date: Dec. 8, 2025

(30) Foreign Application Priority Data
Jun. 9, 2023 (DE) 20 2023 103 185.4

(51) Int. Cl. G01B 11/06; G01B 5/00; G01K 13/06

(52) U.S. Cl. CPC G01B 11/0658; G01B 5/0014; G01K 13/06

(57) ABSTRACT

A device for determining a lacquer coating thickness of a strip in a continuous process, comprising a thickness sensor arranged crosswise to the conveying direction of the strip which, in terms of signalling, is connected to a control unit for determining the thickness of the lacquer coating on the strip, and a temperature sensor for the detection of a temperature of the strip provided in an area T in the conveying direction in front of and/or at a measurement area D of the thickness sensor. The control unit (3) has a module for the temperature compensation of the measurement by the thickness sensor, to which the temperature sensor in terms of signalling is connected directly or indirectly for the correction of a thickness value on the basis of the temperature measured by the temperature sensor.

### CROSS REFERENCE TO RELATED APPLICATIONS

The present application is a U.S. National Phase of International Application No. PCT/EP2024/065830 entitled “APPARATUS AND METHOD FOR DETERMINING A LACQUER COATING THICKNESS ON ELECTRICAL SHEETS”, and filed on Jun. 7, 2024. International Application No. PCT/EP2024/065830 claims priority to German Patent Application No. 20 2023 103 185.4 filed on Jun. 9, 2023. The entire contents of each of the above-listed applications are hereby incorporated by reference for all purposes.

### TECHNICAL FIELD

The present invention relates to a device and a method for the determination of a thickness of a lacquer coating on a strip in a continuous process, in particular a production or processing process of a metal strip or electrical sheet, also designated electrical strip, in which by means of a lacquering- or coating device, a transparent or also pigmented insulation or lacquer coating is applied to the strip. The lacquer coating thickness of such electrical strips or electrical sheets is usually determined by means of different methods and technologies, in order to guarantee the quality of the coating of such insulation coatings or lacquer coatings which are for example in a range of 0.5 μm and 10 μm. The main function of such coatings with insulating lacquer consists in insulating such electrical sheets or electrical strips, in order to prevent an electric flow of current and to reduce eddy currents. In other areas, a coating of such metal strips is also applied for the purpose of corrosion protection or to lengthen a working life of die cutting tools during further processing. The insulation coatings or lacquer coatings are thereby applied by means of different coating or lacquering means in a usually continuous process with continuously running metal strip, wherein at least a thickness sensor is provided in order to determine the lacquer coating thickness in the conveying direction of the strip after the coating and to determine or to inspect a sufficient and uniform coating. Such thickness sensors are provided above and/or below the electrical sheet or -strip after the coating device at corresponding brackets of the system.

### BACKGROUND AND SUMMARY

As a technology for the determination of such lacquer coating thicknesses up to now, besides infrared spectroscopy in particular the method of beta back-scattering was used, in which j-rays from a radioactive source are back-scattered to the metal surface and weakened when passing through the insulating lacquer coating in dependence on the coating thickness thereof. The devices designated as beta back scatter (isotope-)measuring systems have the disadvantage that the availability of the isotopes necessary for this, like krypton, strontium or promethium is increasingly reaching its limits. The beta transmission coating thickness measurement also has the disadvantage that due to the radioactive isotopes, an increased radiation protection is required for the users and the operators in the area of such measuring means. In the case of the beta transmission coating thickness measurement with radioactive rays, usually housings or screens for the reduction of the radiation risk are used. In any case, however, the valid radiation protection regulations must be complied with. As these emitters cannot be switched off and the half-value time of usual isotopes like promethium is approximately two to three years, during which the emitted amount of radiation is then reduced by half, these sensors and emitters are then no longer fit for use. Alternative sources of radiation for such a back scatter radiation measuring device are either too weak or too strong, so that there are no factual alternatives for the isotope promethium, which is not available, or will soon not be available, on the market anymore.

The devices known up to now for lacquer coating thickness measurement furthermore have the disadvantage that, in the case of interference factors from the production process, the measurements often become imprecise, for example when different surface roughnesses occur due to contaminants or the rolled state of the metal strip. Furthermore the climatic conditions in the gap between measurement system and strip surfaces play a considerable role. That means, temperature, air pressure, and humidity have to be permanently measured and also considered in the evaluation. Too large changes in the distance between measurement system (typically 10 to 20 mm) and metal strip of +/−1 mm can already lead to clear differences in the measurement values. The measurement results with the known lacquer coating thickness measurement devices are then wrong and cannot provide for a statement of qualitatively high value regarding the actual lacquer coating thickness.

With this in mind, it is the object of the present invention to provide a device and a method for the determination of the lacquer coating thickness of such strips, in particular of electrical sheets or metal strips, in which a precise determination of the coating thickness and uniformity of the coating application on the metal strip is continuously made possible without being susceptible to interference influences.

This object is solved by a device for the determination of the lacquer coating thickness of a strip and electrical strip as described herein, and a method with the steps described herein.

According to the invention, a device is proposed for the determination of the lacquer coating thickness of a strip in a continuous process, in particular a production or processing process of a metal strip or electrical sheet in which, by means of a lacquering or coating device, a transparent or also pigmented insulation or lacquer coating is applied to the strip, with at least a thickness sensor arranged crosswise to the conveying direction of the strip preferably traversingly or alternatively stationary and which, with regard to signalling, is connected to a control unit for the determination of the thickness of the lacquer coating on the strip, wherein the method is characterised in that at least a temperature sensor for the detection of a temperature of the strip in an area T in conveying direction of the strip is provided in front of and/or at, preferably near to a measurement area D of the thickness sensor, and that the control unit has a module for the temperature compensation of the measurement by the thickness sensor, to which the temperature sensor in terms of signalling is directly or indirectly connected for the correction of a thickness value on the basis of the temperature measured by the temperature sensor.

The thickness sensor of the device according to the invention is therefore at least a sensor by means of which the lacquer coating thickness is detectable. It can be a sensor on the basis of the laser induced fluorescence technology, in which by means of a laser, for example a solid-state laser, through a specific local optical excitation preferably in the ultraviolet spectral range of molecules in the coatings, a glow effect, the so-called fluorescence, is generated on the surface of the metal strip, and from the detection of the emitted fluorescence from the transparent or pigmented lacquer coatings, a determination of the lacquer coating thickness is performed. Preferably a pulsed laser light source is used thereby, which allows a time-resolved evaluation of the laser induced fluorescence signals and thereby provides additional advantages. The laser induced fluorescence spectroscopy is carried out by means of a thickness sensor arranged crosswise over the strip width preferably traversingly, wherein according to the invention an additional measurement of the temperature of the metal strip is performed in an area in strip conveying direction in front of the measurement area D. Alternatively, an IR sensor on the basis of infrared absorption or on the basis of ellipsometry or a combination of these can be used as thickness sensor in the scope of the present invention.

In the case of the IR sensor, a part of the energy of the infrared radiation radiated into the strip surface is absorbed by determined molecular groups in the coatings and converted into thermal molecular vibrations. The energy loss resulting therefrom of the amount of radiation back scattered at the substrate surface of the metal strip under the lacquer coating can be measured by means of a detector as intensity loss in the case of determined wavelengths. According to the Beer-Lambert law of absorption, from this then under defined conditions the coating thicknesses of the lacquer can be determined. Because the back scattering of the measuring radiation at the respective substrate surface is always necessary for the IR method with IR thickness sensors, the composition (roughness, texture) of the surface of the metal strip can have an interfering influence on the coating thickness measurement, in particular in the case of inhomogeneities or changing conditions. In the case of the LIF measurement this has a subordinate influence, as the emission of the fluorescence to be detected is radiated from individual stimulated molecules of the coating above the substrate surface directly isotropically in all spatial directions. The registration of the intensity of a representative amount of this radiation is therefore not reliant on a back scatter process on the substrate surface.

Further methods like for example ellipsometry, which arises on the registration of the change of the polarisation state of an applied radiation in the case of the reflection in the lacquer coating and the substrate surface therebelow of the metal strip, are—with regard to the physical principle—likewise usable in the scope of the present invention.

The thickness measurement by means of the thickness sensor is compensated in the device with regard to the temperature by means of a special control module, that means, an adjustment of the measured results from the measurement of the thickness sensor is performed on the basis of the actual present temperature of the electrical strip in each case.

For the thickness sensors according to the invention, which as an example are based on laser induced fluorescence, it is generated by means of an optical excitation of molecules in the lacquer coatings and coating media by means of the energy of the laser. By means of thermal effects like molecular movement, impacts, chemical effects etc., the measurable entire intensity of the reflected or back scattered fluorescence for a determined wavelength in a defined wavelength range of a coating can be influenced. Hereby it followed from tests by the inventor that the intensity of the fluorescence, which is measured by means of the thickness sensor according to the device according to the invention, reduces with increasing temperature of the strip or electrical strip. The changes due to the temperature of the strip of the fluorescence intensity are thereby in each case dependent on the coating material or lacquer type used. By means of stored data of calibration measurements or known material values, this reduction in the fluorescence in the case of the use of the raw data of the thickness sensor with the device according to the invention can be correspondingly corrected by means of an adjustment of the end results of thickness values. In the control unit according to the invention and the control module for the temperature compensation, these values and corresponding calculation models are stored. The temperature compensation can thereby be performed by means of one single calibration of a system at the beginning of the use of the device. Also, by means of the processing of different coating types or coating materials, different values can be correspondingly used from a databank or by means of inputting into the control unit, in order to achieve the advantages according to the invention of the correct lacquer coating thickness determination over a wide range of applications.

A temperature measurement with a temperature sensor or a plurality of temperature sensors at the measurement area or alternatively at, preferably near to the measurement area D has the advantage and effect according to the invention that possible distortions of the thickness measurement due to the partly very different and also high temperatures of such metal strips in the processing process are prevented. Also in the case of strongly deviating strip temperatures of the metal strip, in this way an exact measurement of the lacquer coating thickness in the mentioned area of, for example, 0.5 μm to 10 μm can take place without the occurrence of, for example, wrong measurement values due to the measurement technology of the laser induced fluorescence spectroscopy.

A temperature measurement can therefore be in a measurement-point or -area, either in conveying direction of the strip in front of the thickness measurement area or, alternatively, overlapping with it in or near to the thickness measurement area. In the latter case, a reciprocal interference of the two must be excluded.

As possible forms of temperature sensors in connection with the present invention, in particular contact-free temperature detectors are used which are based on a measurement of a heat flow (“convective heat flow” sensors). These temperature sensors have a very high accuracy in the range of +/−0.1° C., so that the required high accuracy of the measurement of the temperature of the strip for the compensation of the fluorescence signals in the thickness sensor is made possible directly in a contact-free manner. The temperature sensors based on heat flow have the advantage that they do not need any prone-to-interference optics. But instead they must be mounted relatively near to the area of the surface of the strip, for example at 3 mm to 10 mm, so that they deliver the exact temperature values necessary for the device according to the invention for the thickness determination of lacquer coatings. Other types of temperature sensors are likewise possible in the scope of the present invention: thermal imaging cameras or radiation-based infrared sensors (pyrometers) can also be used.

An important aspect of the radiation based temperature measurement with pyrometers has turned out to be the shielding of the light path in relation to the radiation from the environment. The distance of the system from the strip surface changes according to the optic in front of the pyrometer, in order to guarantee a determined measured point dimension. By means of the suitable selection of an optic, it is therefore possible to produce a mechanical shielding up to distances of 40 mm from the strip surface (corresponds to the distance of the LIF sensor from the strip surface) with small spatial requirement. This minimises the interfering influence of the environmental radiation on the measurement of the strip temperature by means of the thermal radiation emitted from the strip surface. As the pyrometers have the advantage, due to their small structural shape, that they can be mounted in direct spatial proximity to the measurement position of the coating thickness measurement used in each case, a temperature detection in the same area or even directly in the area of the measurement spot of the thickness measurement is possible; provided that the methods of the temperature- and the coating-thickness measurement do not reciprocally influence one another. By means of this local temperature detection it is also possible, already during the calibration of the coating thickness measurement systems in the laboratory, in each case to detect and record the temperatures of individual calibration samples with the same pyrometer types in the same arrangement as additional parameters, as it is later in the system. In this way it is then however no longer necessary to have to measure the factual absolute temperature of the strip, but rather to ensure a determined relationship between the values of the temperature values measured during the calibration and the temperature values measured inline with the pyrometer.

Thereby, coating-specific influences of the radiation based temperature measurement due to changing emission degrees, for example by means of the use of in each case two different pyrometer types or a short term sequential measurement for different emission degrees, could then also be taken into consideration in each case specifically from the beginning. In this way then an exact and specific compensation of the values of the thickness measurement due to the respective influence of the strip temperature would also be possible. Moreover, the local measurement with the pyrometers allows the detection of the temperatures of both strip areas, upper side and lower side separately, and in the case of a traversing measurement, possible gradients in the temperature distribution over the strip width.

The pyrometers can optionally also be combined with heat flow temperature sensors. The temperature sensors should only be contact-free, so that a direct contact with the strip during the production process and the risk of damage or interference of the temperature sensors and also of the strip surface is avoided.

The temperature sensor according to the invention is arranged in an area in strip conveying direction in front of the measurement area of the thickness sensor, so that a determination of the strip temperature for the accuracy of the thickness measurement can be determined in advance and also taken into consideration in the evaluation by means of a temperature compensation. The temperature sensor can also be provided in the measurement area D of the thickness sensor near to the thickness sensor itself, as long as a correct determination of the strip temperature of the metal strip can be obtained. A detection only of the ambient temperature is not decisive and sufficient for the correction and compensation of the measured value during the lacquer coating thickness determination by means of the laser induced fluorescence method or other thickness measurement methods, but should also be included as an additional process parameter according to an optional embodiment in the scope of the present invention.

The temperature sensor can be a single sensor, which in terms of signalling is connected to the control module for the compensation of the measurement results of the thickness sensor. Also, a plurality of temperature sensors and/or a plurality of thickness sensors can be provided, so that then a traversing arrangement of the thickness sensors is not positively necessary anymore.

With the device according to the invention, clear advantages can be obtained in relation to the prior art of such devices for lacquer coating thickness measurement: the influences of interference factors from the production process are in particular greatly reduced in the case of the laser induced fluorescence but also in the case of other thickness measurement methods, in particular with regard to the surface roughness.

According to an advantageous embodiment of the invention, the temperature sensor or the at least one temperature sensor of the device is a contact-free sensor positioned stationary at the strip. The sensor does not have to be arranged traversing over the strip width, but instead can be provided stationary at a place, for example at a middle area of the metal strip. Alternatively, the temperature sensor can also be arranged at a bracket together with the thickness sensor, traversing—therefore crosswise to the strip conveying direction. However, the stationary assembly of the temperature sensor has the advantage that a relatively small effort for the construction of the device is required with regard to this. The connection to the control unit and the control module for the signal transmission of the temperature for the temperature compensation can be performed by means of a wireless or by means of a wired signal line. The connection with the detected thickness values of the thickness sensor is then performed in the control unit and the control module with the temperature, in order to bring them into connection, so that a temperature compensation can be performed directly and continuously during a processing process of the electrical strip. A high quality of the lacquer coating thickness determination is therefore continuously guaranteed with a relatively simple constructional embodiment of the device.

According to a further advantageous embodiment of the invention, the at least one temperature sensor is arranged in a measurement area T in strip conveying direction in front of and near to the measurement area D of the thickness sensor at a distance of 1 cm to 200 cm, in particular 10 cm to 200 cm from the measurement area D. In this way, a temperature determination of the temperature of the metal strip is performed in an area relatively near to the measurement area D of the thickness sensor, but at a determined distance therefrom. Therefore it is prevented that a reciprocal interference occurs between the measurement of the thickness sensor and the temperature measurement. Using the information of the actual temperature of the strip, the measurement of the thickness sensor can then be correspondingly corrected in the control module of the control unit. The raw data of, for example, the fluorescence measurement with the thickness measuring means, are corrected using the information with regard to the strip temperature; that is, according to how high the temperature is, an adjustment to the results of the fluorescence measurement with the thickness sensor is carried out in the control unit on the basis of stored data. By means of this measure, even more exact measurement results of the thickness measurement are obtained by means of the device according to the invention.

The thickness sensor in the case of a fluorescence measurement comprises for example a solid state laser, which at a high frequency in a preferably slightly offset alignment (for example 60°) sends laser beams aimed at the metal strip, which stimulate the lacquer or the coating on the metal strip to glow, due to the material composition. The back-scattered glow values are determined by the thickness sensor, and in the control unit based on this glow effect an exact coating thickness determination of the lacquer coating is obtained. The correction with the current temperature of the strip according to the invention makes it possible to produce a correct statement of the lacquer coating thickness by means of the device even in the case of very different temperatures. In the control unit, for example data with regard to the influence of the temperature on the fluorescence effect of the thickness sensor according to the material of the coating or of the lacquer type, are stored. In this way a compensation for the correction determination of the correct thickness value can be performed even in the m range—as a rule 0.5 μm to 10 μm—by means of the device according to the invention in a wide range of applications of such strip coatings.

According to a further advantageous embodiment of the invention, at least a temperature sensor is provided integrated at the thickness sensor or integrated at a bracket of the thickness sensor. The device can therefore be realised even more compact and with smaller construction size. The mounting of the temperature sensor then does not require a separate retainer, when the temperature sensor is provided integrated at the bracket of the thickness sensor or near to it in the area of the thickness sensor itself. An integration further has the advantage that the temperature measurement corresponding to the measurement point or measurement area of the thickness sensor is carried out in each case directly corresponding. The temperature measurement is therefore in each case a very exact current determination of the temperature of the metal strip at the measurement place in each case of the sensor for the thickness determination. The influence of the temperature of the metal strip on the fluorescence effect, which is used with the device according to the invention, is therefore very small after the compensation by means of the control unit. For the solution according to the invention, it is essential that the temperature sensor is arranged near to the thickness sensor and that the measurement area of the temperature sensor is near to that of the thickness sensor or also directly overlaps with it. An overlapping is not useful only if a reciprocal influencing of the measurement systems would lead to possible interferences of the measurement results. With the solution according to the invention, interference effects due to increased temperature at the metal strip can be compensated with a relatively small amount of additional equipment. Also, in this way a thickness measurement of the lacquer layers or coatings of the electrical strips can be carried out in a relatively large area by means of the method of the laser induced fluorescence technology or alternative other measuring methods, without the requirement of complex additional measures or complex measuring means.

According to a further advantageous embodiment of the invention, a plurality of temperature sensors is provided distributed over a width direction of the strip. By means of a plurality of temperature sensors, different temperatures in different areas of the metal strip can also be taken into consideration in the compensation for the lacquer coating thickness determination. For example, two or four stationary temperature sensors can be arranged distributed evenly over the width, which measure the metal strip with regard to temperature over the whole width. The values detected by the temperature sensors are transmitted as signals to the control unit, in which the compensation of the measurement of the thickness sensor is then performed, by using stored values of the fluorescence with the respective laser sensors or similar sensors of the thickness sensor as a basis and, based on this, the adaptation and compensation of the raw data of the measured values of the thickness sensor is performed by increasing or decreasing the thickness values.

The present invention also relates to a method for the determination of a lacquer coating thickness of a strip in a continuous process. The method according to the invention is in particular provided for the realisation with a system or device having the features described herein, although alternative devices may also carry out the method steps described herein in some cases.

According to the invention a method is proposed for the determination of a lacquer coating thickness of a strip in a continuous process, in particular a production or processing process of a metal strip or electrical sheet in which, by means of a lacquering or coating device, a transparent or pigmented insulation or lacquer coating is applied to the strip, with at least a thickness sensor which is arranged crosswise to the conveying direction of the strip and which, in terms of signalling, is connected to a control unit for the determination of the thickness of the lacquer coating on the strip, wherein the method is characterised by:
detection of a temperature of the strip in an area T in conveying direction of the strip in front of a measurement area D of the thickness sensor by means of at least a temperature sensor;
transmission of the measured temperature to the control unit and/or a module of the control unit;
temperature compensation of the measurement by the thickness sensor by means of a module in the control unit, to which the temperature sensor in terms of signalling is connected directly or indirectly for the correction of a thickness value on the basis of the temperature measured by the temperature sensor.

According to an advantageous embodiment of the method according to the invention, the thickness measurement takes places on the basis of a laser induced fluorescence technology (LIF).

According to an advantageous embodiment of the invention, the temperature is measured by means of a convective heat flow sensor or by means of a pyrometer.

### BRIEF DESCRIPTION OF THE FIGURES

Further advantages, features and aspects of the present invention are described in detail in the following, wherein reference is made to the attached drawings in which a plurality of embodiments of the invention is shown. In the Figures it is shown as follows:

FIG. 1 shows a schematic view of an embodiment of a device according to the invention for coating thickness measurement with a temperature detection in strip conveying direction in front of the thickness sensors; and

FIG. 2 shows a diagram for the illustration of the temperature influence on fluorescence signals of a thickness sensor of a device according to the invention.

### DETAILED DESCRIPTION

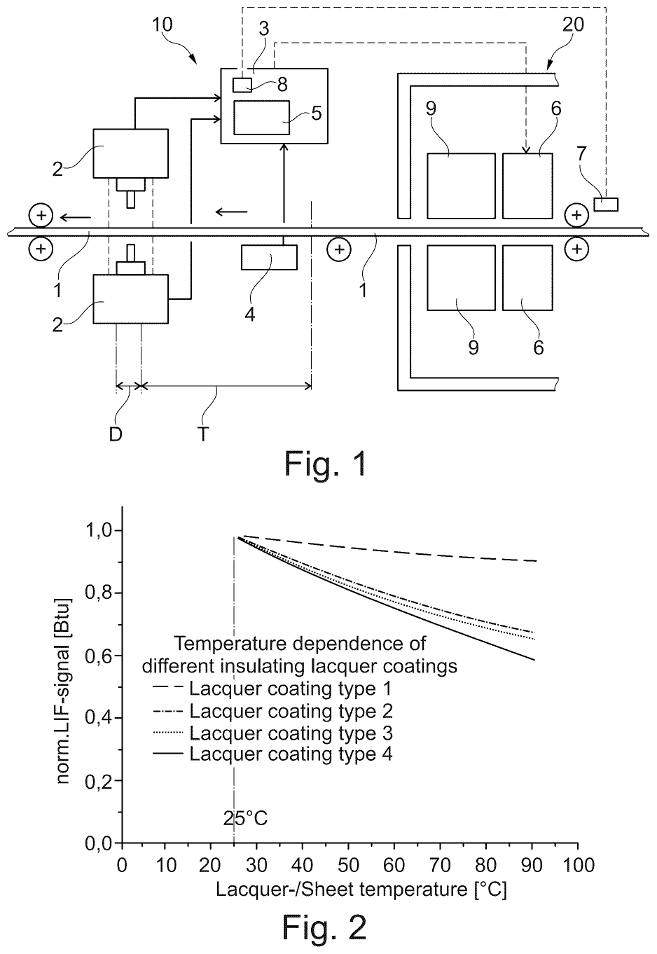

In FIG. 1, a schematic view of a first embodiment of a device 10 according to the invention for the coating thickness measurement of a coating or lacquer coating of strips 1 is represented, with a temperature detection in strip conveying direction in front of the thickness sensor(s) 2, as can also be used for the performance of the method according to the invention. In this embodiment of FIG. 1 the device 10 comprises in each case a thickness sensor 2 arranged above and below the strip 1 or electrical strip, which here in this first example is based on a laser induced fluorescence technology. Hereby, with a relatively high frequency a laser beam is sent usually slightly offset to the surface of the strip 1 and the emitted fluorescence light is detected in the thickness sensor 2 and conveyed to a control unit 3. In the control unit 3, the determination of the actual thickness of the coating on the strip 1 then takes place, which can be for example an insulation coating or lacquer coating on an electrical strip 1 or metal strip. Alternatively, an infrared sensor, a sensor based on ellipsometry, or a combination thereof can be used for the thickness measurement in the scope of the present invention.

Such a coating or lacquer layer usually has a transparent form or a form pigmented such that it is light-permeable, and a thickness in a range of usually 0.5 μm to 10 μm. Such lacquer coatings or insulation coatings are in particular applied to strips as so-called electrical strips, in order to provide a corrosion protection or in order to obtain an electrical insulation. As well as having the thickness sensors 2 or at least a thickness sensor 2 and the control unit 1, the device 10 according to the invention also has at least a temperature sensor 4, which in this embodiment is arranged in strip conveying direction in front of the thickness sensor 2 below the strip 1 (compare direction of arrow of the strip 1 in FIG. 1). The strip 1 is coated with the insulation coating or lacquer coating in an upstream coating device 20, for example by means of roll coaters 6, and after that the coating is dried in a drying unit 9. After this process of the coating in the coating device 20, a control and testing of the actual lacquer thickness of the application on the strip 1 has to be carried out, in order to guarantee the standard and quality of the electrical strip or metal strip 1. By means of the device 10 according to the invention, the raw data of the measurement values of the thickness sensors 2 in the control unit 3 are compensated and corrected via a specific temperature compensation module 5. The temperature measurement values of the temperature sensor 4, which detect in a contact-free manner the actual temperature of the strip 1 at the place in front of the measurement area D in a temperature measurement area T, are input into the temperature compensation module 5. The raw data of the thickness measurement values from the measurement of the thickness sensors 2 are then compensated and correspondingly corrected using the temperature values in the control unit 3, in order to determine correct values for the actual thickness of the coating of the metal strip 1.

The temperature sensor 4 in this embodiment according to FIG. 1 is arranged below the metal strip 1 in the area T in front of the measurement area of the thickness sensor D and near to a guide roller under the strip 1. Therefore it is guaranteed that the temperature sensor 4 for the exact temperature measurement is arranged sufficiently near to the strip 1 and cannot be damaged. The temperature sensor 4 can be provided with an automatic, mechanical movement means by means of an additional distance sensor. In this way it is always held at the right distance from the strip surface even during strip fluctuations. Moreover, during the passing through of a weldseam of two strips, the temperature sensor can also be moved away to a larger distance from the strip for the avoidance of damage. The temperature sensor 4 is preferably a contact-free sensor which performs a contact-free temperature measurement on the heat flow process, a so-called convective heat flow detector. Alternatively or additionally, thermal imaging cameras or contact-free radiation-based temperature measurement means, so-called pyrometers, can be provided.

The temperature sensor 4 can be assembled stationary in front of the thickness sensors 2 at a separate bracket which is mounted as near as possible at the strip. Alternatively the temperature sensor 4 can be integrated in a bracket of the thickness sensors 2, and near to the measurement area D the thickness sensors 2 perform the temperature measurement for the compensation according to the invention of the fluorescence values or other measured thickness values in the control unit 3 and the corresponding compensation module 5. The compensation of the measurement values from the measurement of the thickness sensors 2 which are given to the control unit 3 as raw data in terms of signalling, is performed for the comparison of the fluorescence values, usually decreasing with increasing temperature, of substance-specific properties of such coatings. In the case of a nominal temperature of, for example, 25° C., the nominal value of the fluorescence which is measured by means of thickness sensors 2 is usually a correct value (compare FIG. 2). With increasing temperature, however, according to the material type or kind of the coating (lacquer coating type) this value decreases and must then usually be corrected upward in the range up to 40%.

The relationship between the decreasing fluorescence of the raw data and the correction values according to the temperature of the strip 1 is illustrated in FIG. 2, wherein they are represented for different lacquer coating types 1, 2, 3 and 4. In the control unit 3 and the temperature compensation module 5 of the control unit 3, the corresponding values are either stored in a databank or, during set-up of the device 10 or separately under laboratory conditions, are correspondingly detected and adjusted. A calibration for the specific case of application of the device 10 is also possible. By means of the compensation with the actual temperature, which is present at the strip 1 and therefore in the coating at the strip 1, values of the thickness of the coating which are as exact as possible can be determined by means of the device 10 according to the invention. The control unit 3 with the temperature compensation module 5 is adapted and configured either in terms of programming as software or in the form of a hardware, in order to perform such a temperature compensation in the coating thickness measurement of the device 10 with the thickness sensors 2: for this, the correlations between the strip temperature and the thickness values, for example fluorescence thickness values, of such coating thickness measurement by means of the thickness sensors 2, are stored in a databank or as input values of the control unit 3, as illustrated in FIG. 2. A way of proceeding in a programme module of such a temperature compensation module 5 according to the invention can be as follows, by way of the example of the fluorescence thickness measurement:

The temperature correction of the fluorescence data takes place in the control unit 3 of the measurement system in the temperature compensation module 5 for example in the following steps:

### Step 1:

Detection at the same time of the fluorescence at a surface position by means of the thickness sensors 2 and of the strip temperature by means of the sensors 4 spatially as close as possible to the fluorescence measurement with a suitable temperature sensor 4, typically in 10 ms work-cycle.

### Step 2:

Selection of the temperature compensation function from a databank in the control unit 3 with lacquer coating-specific parameters (current lacquer coating type as specification from the process data), which are stored in an associated databank/file in the system calibration.
Typical function: second degree polynomial (3 parameters) or linear function (2 parameters)

### Step 3:

Calculation of a correction factor in the module 5 of the control unit 3 from the selected temperature compensation function with the associated lacquer-specific parameters for the current detected measurement values of the strip temperature.

### Step 4:

Application of the detected correction factor to the currently measured fluorescence value and calculation of the corrected fluorescence intensity for the thickness measurement of the device 10.

### Step 5:

Calculation of the current coating- or layer-thickness value from the corrected fluorescence value with the lacquer coating-specific associated calibration function stored in the databank of the system.

### Step 6:

Output or further calculation (for example, averaging) of the current coating- or layer-thickness value at a display unit of the device 10 or process control unit.

The measurement values of the coating thicknesses by means of the device 10 are usually the coatings of the lacquer coatings which are present, in g/m² or a coating thickness calculated therefrom in m. However, it is a precondition of the coating thickness determination as m that the exact density values of the lacquer coating in each case on the strip 1 of the dried lacquer are known or are calculated from known formulas or past values correspondingly in the control unit 3 and the module 5. For this, for example a gravimetric method for thickness determination according to DIN ISO EN 3233-2 is used.

According to a further advantageous embodiment of the invention a backscatter measurement unit 7 is provided, by means of which a measurement of the backscatter from the strip surface of the strip 1 is performed. Furthermore a backscatter compensation module 8 in the control unit 3 is provided integrated, which in terms of signalling is linked with the back scatter measurement unit 7. In this way, besides the temperature compensation according to the invention a correction or compensation of the backscatter influence on such lacquer coatings of electrical strips or other strips 1 can also be advantageously performed. Such an optional embodiment of the invention with backscatter compensation has advantages in particular for applications like the electrical sheet coating with insulation lacquer coatings, because in this case the steel strips can be used without further surface finishing in the cold-rolling mill. The roughness and standard of the surface of such strips 1 or steel surfaces is therefore usually not always very good and can fluctuate, which can then have an influence on the measurement values of the thickness measurement. These influences can be compensated by means of the measurements with a backscatter sensor likewise according to the invention, so that here a relatively exact and correct determination of the actual coating thickness of such strips 1 is made possible. This optional embodiment is schematically illustrated in FIG. 1 by means of the dotted line for the control signal.

According to a further alternative embodiment of the invention, a feedback from the thickness measurement in the device 10 to the coating device 20 can be performed, as likewise illustrated by means of the dotted line in FIG. 1. Therefore it is possible to directly influence the coating process by means of the coating elements and roll coaters 6 of the coating device 20, in the case that there are deviations from a standard value of the thickness of the insulation coating or coating of the strips 1.

List of reference numbers

| | |
|---|---|
| 1 | Strip or electrical sheet |
| 2 | Thickness sensor |
| 3 | Control unit |
| 4 | Temperature sensor |
| 5 | Temperature compensation module |
| 6 | Coating elements or roll coaters |
| 7 | Back scatter measuring unit |
| 8 | Back scatter compensation module |
| 9 | Drying unit |
| 10 | Device for determination of lacquer coating thickness |
| 20 | Coating and drying device |
| D | Measurement-area thickness sensor |
| T | Measurement-area temperature sensor |

1. A device for determining a lacquer coating thickness of a strip in a continuous process, comprising at least:
a thickness sensor which is arranged crosswise to a conveying direction of the strip and which, in terms of signalling, is connected to a control unit for determining the lacquer coating thickness of the strip, and
a temperature sensor for detection of a temperature of the strip provided in an area T in the conveying direction of the strip, in front of and/or at a measurement area D of the thickness sensor,
wherein the control unit has a module for temperature compensation of the measurement by the thickness sensor, to which the temperature sensor in terms of signalling is connected directly or indirectly for correction of a thickness value on the basis of the temperature measured by the temperature sensor.

2. The device according to claim 1, wherein the temperature sensor is integrated at the thickness sensor or at a bracket of the thickness sensor.

3. The device according to claim 1, wherein the temperature sensor is a sensor positioned stationary and contact-free at the strip.

4. The device according to claim 1, wherein the temperature sensor in the measurement area T in the conveying direction is arranged near to or overlapping with the measurement area D of the thickness sensor at a distance of 1 cm to 200 cm from the measurement area D.

5. The device according to claim 1, wherein a plurality of temperature sensors is provided distributed over a width direction of the strip.

6. The device according to claim 1, wherein the temperature sensor is a convective heat flow sensor based on the flow of heat or a pyrometer.

7. The device according to claim 1, wherein the thickness sensor is a thickness sensor based on laser induced fluorescence.

8. The device according to claim 1, wherein a back scatter measuring unit for measuring an actual back scatter from the surface of the strip and a back scatter compensation module are provided in the control unit for the correction of a thickness value of the thickness sensor.

9. The device according to claim 1, wherein the temperature sensor has a shield in relation to ambient temperature influences and for the focusing on a measuring-point or -area on the strip.

10. A device for determination of a lacquer coating thickness of a strip in a continuous process, comprising at least:
a thickness sensor which is arranged crosswise to a conveying direction of the strip and which is based on laser induced fluorescence technology and, in terms of signalling, is connected to a control unit for determination of the lacquer coating thickness of the strip, and
a temperature sensor for detection of a temperature of the strip provided in an area T in the conveying direction of the strip in front of a measurement area D of the thickness sensor,
wherein the control unit has a module for temperature compensation of the laser induced fluorescence measurement by means of the thickness sensor with which the temperature sensor is directly or indirectly connected in terms of signalling, for correction of a thickness value on the basis of the measured temperature.

11. (canceled)

12. A method for determination of the lacquer coating thickness of a strip in a continuous process, wherein the continuous process is a production or processing process of a metal strip or electrical sheet with the device according to claim 1 in which, by means of a lacquering or coating device, a transparent or pigmented insulation or lacquer coating is applied to the strip, wherein the method comprises:
detection, with the temperature sensor, of a temperature of the strip in an area T in the conveying direction of the strip in front of the measurement area D of the thickness sensor;
transmission of the measured temperature to the control unit and/or a module of the control unit; and
temperature compensation of the measurement by means of the thickness sensor by means of a module in the control unit, to which module the temperature sensor in terms of signalling is directly or indirectly connected for the correction of a thickness value on the basis of the temperature measured by the temperature sensor.

13. The method according to claim 12, wherein the thickness measurement of the lacquer coating thickness is performed by means of a laser induced fluorescence measurement.

14. The method according to claim 12, wherein the temperature is measured by means of a convective heat flow sensor or by means of a pyrometer sensor.

15. The device according to claim 1, wherein the continuous process comprises a production or processing process of a metal strip or electrical sheet in which, by means of a lacquering or coating device, a transparent or pigmented insulation or lacquer coating is applied to the strip.

16. The device according to claim 1, wherein the thickness sensor is arranged traversingly to the conveying direction.

17. The device according to claim 1, wherein the temperature sensor is positioned near to the measurement area D of the thickness sensor.

18. The device according to claim 4, wherein the temperature sensor in the measurement area T in the conveying direction is arranged near to or overlapping with the measurement area D of the thickness sensor at a distance of 10 cm to 50 cm from the measurement area D.

19. The device according to claim 10, wherein the continuous process comprises a production or processing process of a metal strip or electrical sheet, in which by means of a lacquering or coating device a transparent or pigmented insulation or lacquer coating is applied to the strip.

20. The device according to claim 10, wherein the thickness sensor is arranged traversingly to the conveying direction.
